(19) United States
(12) Patent Application Publication
(10) Pub. No.: US 2026/0095276 A1
(43) Pub. Date: Apr. 2, 2026

(54) Retransmission Packet Combining at the Receiver

(71) Applicant: Apple Inc., Cupertino, CA (US)

(72) Inventors: Imran Latif, Pleasanton, CA (US); Narayanan Raman, Sunnyvale, CA (US)

(21) Appl. No.: 18/900,563

(22) Filed: Sep. 27, 2024

(51) Int. Cl. H04L 1/1829

(52) U.S. Cl. CPC H04L 1/1845; H04L 1/1861

(57) ABSTRACT

A method of retransmission packet combining at a receiver is disclosed. The method comprises determining, at the receiver, a noise level for a plurality of channels. A first signal is received comprising a packet. The receiver may attempt to decode the packet at the receiver, and send a request to a transmitting device to retransmit the packet when the attempt to decode the packet fails and the noise level for the plurality of channels is greater than a threshold level. The receiver can receive up to M retransmissions of the first signal comprising the packet, and combine the received first signal with one or more of the M received retransmissions of the first signal to form a combined signal. The packet in the combined signal can be decoded based on the combined signal.

### FIELD

Embodiments relate to wireless communications, including apparatuses, systems, and methods for decoding packets with retransmission combining at the receiver.

### DESCRIPTION OF THE RELATED ART

Wireless communication in local area networks (LANs) and personal area networks (PANs) is commonly conducted using shared radio frequency (RF) bands, such as industrial, scientific, and medical (ISM) bands. The ubiquitous use of the publicly available ISM bands leads to the significant potential for congestion and interference. The use of other RF devices, such as microwave ovens, which also operate within an ISM band, can create broadband interference at relatively high power levels. This can affect the performance of real-time or near real-time communication using devices that communicate in the ISM bands, which can negatively impact user experience.

### BRIEF DESCRIPTION OF THE DRAWINGS

A better understanding of the present subject matter can be obtained when the following detailed description of various embodiments is considered in conjunction with the following drawings.

FIG. 1 illustrates an example wireless communication system including wireless devices configured to communicate using a Bluetooth protocol, according to some embodiments.

FIG. 2 illustrates an example block diagram of a wireless device, according to some embodiments.

FIG. 3A illustrates an example diagram of a Bluetooth low energy (BLE) frequency band with 40 channels each having a 2 Megahertz (MHz) bandwidth, according to some embodiments.

FIG. 3B illustrates an example of a Bluetooth low energy (BLE) protocol stack, according to some embodiments

FIG. 4 illustrates an example timing diagram of a Bluetooth communication configuration, according to some embodiments.

FIG. 5 illustrates an example timing diagram of Bluetooth synchronization setup between wireless devices, in accordance with some embodiments.

FIG. 6 illustrates an example of a time division duplex (TDD) transmission scheme with multi-slot packets and frequency hops f(k), in accordance with some embodiments.

FIG. 7 illustrates an example illustration of a flowchart for adaptive frequency hopping in accordance with some embodiments.

FIG. 8 is an example of a BLE link layer protocol data unit (PDU) in accordance with some embodiments.

FIG. 9 a flowchart of an example of a process of Bluetooth radio decoding with retransmission combining at the receiver, according to some embodiments.

FIG. 10 is a flowchart of an example of a method of combining packet retransmission at a Bluetooth receiver, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium or Memory—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Bluetooth—a short-range wireless technology standard that is used for exchanging data between fixed and mobile devices. Bluetooth includes two different types of devices, typically referred to as Bluetooth Classic (BTC) and Bluetooth Low Energy (BLE). BTC comprises Bluetooth specification release 1.0 to 3.0. BLE comprises Bluetooth specification release 4.0 to 6.0.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of stations include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, Internet of Things, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or may be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station or Access Point (AP)—The term “Base Station” or “Access Point” has the full breadth of its ordinary meaning, and at least includes a wireless communication station installed at a fixed location and used to communicate with UEs as part of a wireless communication system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

IEEE 802.11—refers to technology based on the Institute of Electronics and Electrical Engineers (IEEE) 802.11 wireless standards such as 802.11a, 802.11.b, 802.11g, 802.11n (Wi-Fi 4), 802.11-2012, 802.11ac (Wi-Fi 5), 802.11ad, 802.11ax (Wi-Fi 6 and 6E), 802.11ay, 802.11be (Wi-Fi 7), 802.11bn (Wi-Fi 8) and/or other IEEE 802.11 standards. IEEE 802.11 technology may also be referred to as “Wi-Fi” or “wireless local area network (WLAN)” technology.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, 3GPP LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, such as Wi-Fi, WLAN channels may be 22 MHz wide, while Bluetooth channels may be 79 channels that are 1 MHz wide for a BTC system or 40 channels that are 2 MHz wide for BLE systems. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to apparatuses, systems and methods for reducing energy usage by network components, e.g., base stations in wireless communication systems.

The example embodiments are described with regard to communication between a wireless device configured to communicate according to a Bluetooth specification. However, reference to wireless device, primary wireless device, secondary wireless device, Bluetooth receiver, or Bluetooth transmitter is merely provided for illustrative purposes. The example embodiments may be utilized with any electronic component that may establish a connection between wireless devices that are configured with the hardware, software, and/or firmware to support wireless communication in short distances, such as less than 10 meters or less than 100 meters. Therefore, the wireless devices as described herein is used to represent any appropriate type of electronic component.

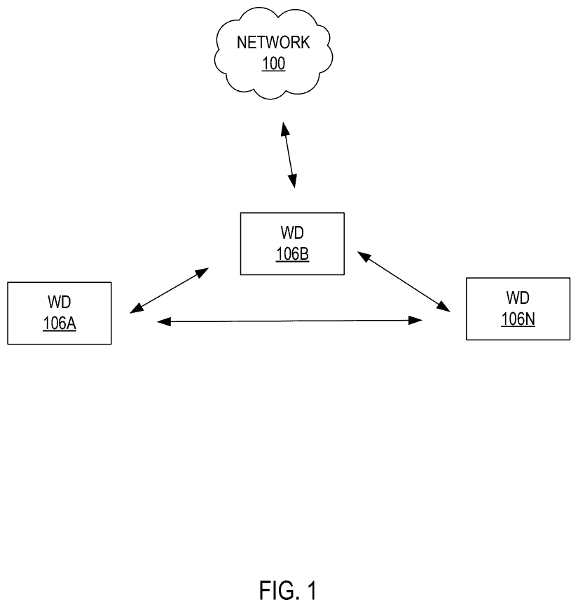

### FIG. 1: Wireless Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a wireless device (WD) 106 which communicates over a transmission medium with one or more other wireless devices 106A, 106B, etc. Each of the wireless devices may be configured to communicate using a Bluetooth communication protocol, including BTC and/or BLE.

The wireless device 106 may be a device with wireless network connectivity such as a mobile phone, a hand-held device, a laptop, a wearable device, a computer or a tablet, an automobile, or virtually any type of wireless device. The wireless device 106 may include a processor (processing element) that is configured to execute program instructions stored in memory. The wireless device 106 may perform any of the method embodiments described herein by executing such stored instructions. Alternatively, or in addition, the wireless device 106 may include a programmable hardware element such as an FPGA (field-programmable gate array), programmable logic device (PLD), application specific integrated circuit (ASIC), an integrated circuit, and/or any of various other possible hardware components that are configured to perform (e.g., individually or in combination) any of the method embodiments described herein, or any portion of any of the method embodiments described herein.

The wireless devices 106A through N may communicate with a network 100 (e.g., a core network of a cellular service provider, a telecommunication network such as a public switched telephone network (PSTN), or a fully digital phone network, and/or the Internet, among various possibilities). Thus, each wireless device may use the network 100 to communicate over longer distances or access the internet.

The communication area (or coverage area) of the wireless devices 106A through N may be referred to as a personal area network, or “PAN”. Each wireless device 106A through N can be configured to communicate over the transmission medium using a Bluetooth wireless technology standard. The Bluetooth wireless technology standard includes the release of the Bluetooth Core Specification Versions 1.0, 1.0B, 1.1, 1.2, 2.0, 2.1, or 3.0, which are commonly referred to as Bluetooth Classic (BTC), or Versions 4.0, 4.1, 4.2, 5, 5.1, 5.2, 5.3, 5.4, or 6.0, which are commonly referred to as Bluetooth Low Energy (BLE). While the examples disclosed herein will focus on communication via Bluetooth, the wireless devices 106A through N can also include additional radio access technologies (RATs) for local area network (LAN) communications, such as the IEEE 802.11 Wi-Fi standard, and wide area network (WAN) communications, such as the third generation partnership project (3GPP). 3GPP standards include 4G, Long term evolution (LTE), LTE-Advanced (LTE-A), and 5G new radio (5G NR).

Wireless devices 106A-N operating according to one or more radio access technologies may thus be provided as a network of cells, which may provide continuous or nearly continuous overlapping service over a geographic area via one or more radio access technology.

The wireless devices 106A-N may include handheld devices such as smart phones or tablets, wearable devices such as smart watches or smart glasses, and/or may include any of various types of devices with cellular communications capability. For example, one or more of the wireless devices 106A-N may be a wireless device intended for stationary or nomadic deployment such as an appliance, measurement device, control device, etc.

Each wireless device 106A-N, which may be referred to singly as a wireless device 106, may include one or more devices or integrated circuits for facilitating wireless communication, potentially including a cellular modem and/or one or more other wireless modems. The wireless modem(s) may include one or more processors (processor elements), and various hardware components as described herein. The wireless device 106 may perform any of the method embodiments described herein by executing instructions on one or more programmable processors. Alternatively, or in addition, the one or more processors may be one or more programmable hardware elements such as an FPGA (field-programmable gate array), programmable logic device (PLD), application specific integrated circuit (ASIC), or other circuitry, which is configured to perform any of the method embodiments described herein, or any portion of any of the method embodiments described herein.

The wireless device 106 may include one or more antennas for communicating using one or more wireless communication protocols or radio access technologies. In some embodiments, the wireless device 106 might be configured to communicate using a single shared radio. The shared radio may couple to a single antenna, or may couple to multiple antennas (e.g., for MIMO) for performing wireless communications. Alternatively, the wireless device 106 may include two or more radios, each of which may be configured to communicate via a respective wireless link. Other configurations are also possible.

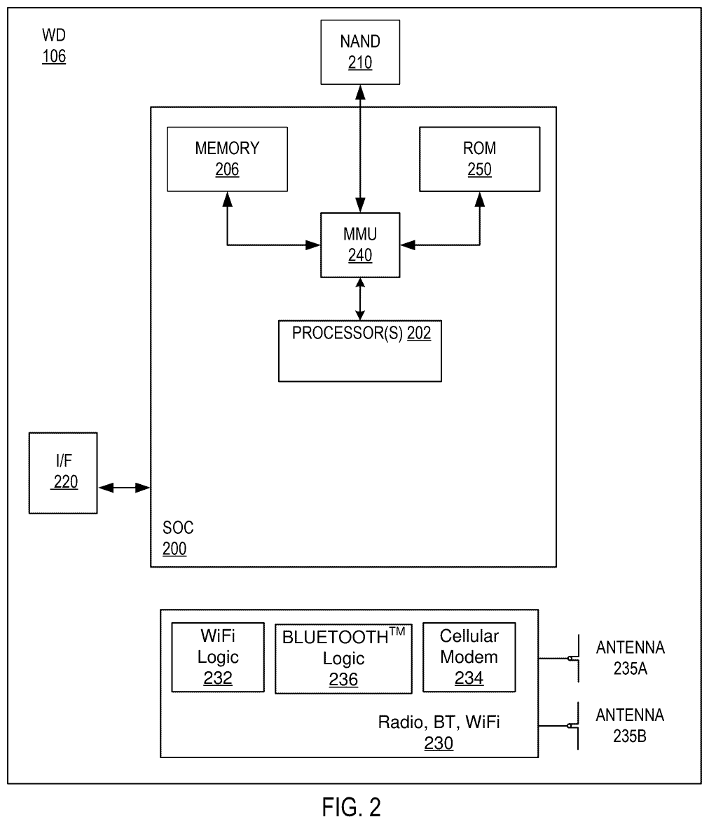

### FIG. 2: Block Diagram of a Wireless Device

FIG. 2 illustrates one possible block diagram of a wireless device, such as wireless device 106, configured to communicate according to a Bluetooth specification. As shown, the wireless device 106 may include a system on chip (SOC) 200, which may include portions for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 200 may be coupled to various other circuits of the wireless device 106. For example, the wireless device 106 may include various types of memory (e.g., including NAND flash 210), a connector interface 220 (e.g., for coupling to a computer system, dock, charging station, etc.), a display, and wireless communication circuitry 230 (e.g., for Bluetooth, Wi-Fi, LTE, LTE-A, NR, NFC, etc.).

As shown, the SOC 200 may include processor(s) 202 which may execute program instructions for the station 106. The processor(s) 202 may also be coupled to memory management unit (MMU) 240, which may be configured to receive addresses from the processor(s) 202 and translate those addresses to locations in memory (e.g., memory 206, read only memory (ROM) 250, flash memory 210). The MMU 240 may be configured to perform memory protection and page table translation or set up. In some embodiments, the MMU 240 may be included as a portion of the processor(s) 202.

The wireless device 106 may include at least one antenna, and in some embodiments, multiple antennas 235A and 235B, for performing wireless communication with other wireless devices, access points, and/or base stations. For example, the wireless device 106 may use antennas 235A and 235B to perform the wireless communication. As noted above, the wireless device 106 may in some embodiments be configured to communicate wirelessly using a plurality of wireless communication standards or radio access technologies (RATs).

The wireless communication circuitry 230 may include Bluetooth Logic 236, Wi-Fi Logic 232, a cellular modem 234, and. The Bluetooth Logic 236 is for enabling the wireless device 106 to perform Bluetooth communications. The Wi-Fi Logic 232 is for enabling the wireless device 106, operating as STA, to perform Wi-Fi or other WLAN communications on an IEEE 802.11 network. The cellular modem 234 may be a cellular modem capable of performing cellular communication according to one or more cellular communication technologies such as 3GPP.

In some embodiments, the wireless communication circuitry 230 may include its own processing element (e.g., a baseband processor and/or control processor), e.g., in addition to the processing element 202. For example, the processing element 202 may be (or include) an ‘application processor’ whose function may include supporting application layer operations in the device 200, while the wireless communication circuitry 230 might include a ‘baseband processor’ (or functionally similar component(s)) whose function may include supporting baseband layer operations (e.g., to facilitate wireless communication between the device 200 and other wireless devices) in the device 200. In other words, in some cases the device 200 may include multiple processing elements (e.g., may be a multi-processor device). Other configurations (e.g., instead of or in addition to an application processor/baseband processor configuration) utilizing a multi-processor architecture are also possible.

In some embodiments, one or more of the Bluetooth Logic 236, Wi-Fi Logic 232, and/or the cellular modem 234 Logic may include its own processing element (e.g., a baseband processor, control processor, or functionally similar components), e.g., in addition to the processor(s) 202. For example, the processor(s) 202 might be (or include) an ‘application processor’ that functions to support application layer operations in the wireless device 106, while one or more of the Wi-Fi Logic 232, the Cellular modem 234, and/or the Bluetooth Logic 236 may include a baseband processor that functions to support baseband layer operations for the applicable RAT.

As described herein, wireless device 106 may include hardware and software components for implementing embodiments of this disclosure. For example, one or more components of the wireless communication circuitry 230 (e.g., Wi-Fi Logic 232, cellular modem 234, Bluetooth Logic 236) of the wireless device 106 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

The block diagram illustrated in FIG. 2 is provided as one example. However, it is not intended to be limiting. Various elements and steps may be removed or performed differently. For example, a simplified wireless device 106 may only include a processor 202, memory 206, and wireless communication circuitry 230 configured to operate as a Bluetooth transceiver. An intermediate complexity wireless device 106 may comprise a processor 202, memory 206, and wireless communication circuitry 230 configured to operate as a Bluetooth transceiver and a Wi-Fi transceiver. A complex wireless device 106 may comprise all of the elements illustrated in FIG. 2, and additional components such as a display screen, display circuitry, motion detection circuitry, and the like.

### Background of Bluetooth Communications

The Bluetooth Standard is one of the most prolific and successful communication standards in history. The Bluetooth standard, was first released in 1998 for short range wireless communication, typically less than 10 meters, with a transmit power of 2.5 milliwatts (mW). However, longer range communication, up to 100 meters, may be possible using Bluetooth. The standard has been continuously improved to provide, among other things, communication with higher quality of service (QOS), higher data rates, and more efficient power usage. Release 1.0 to 3.0 of the standard are referred to as Bluetooth classic (BTC). A new standard released as Rel. 4.0 is incompatible with the earlier releases, and is referred to as Bluetooth Low Energy (BLE). Both standards are still supported. BTC can transmit at higher data rates, while BLE can transmit with lower power consumption, as the name implies.

Bluetooth communication is primarily designed for communication between two wireless devices. One of the wireless devices is referred to as the primary wireless device (e.g. master device), and the other wireless device is referred to as the secondary wireless device(s) (e.g. slave device). The primary wireless device controls the clock for communication with one or more secondary devices. The primary wireless device, such as 106A in FIG. 1, can communicate with up to 7 secondary devices, 106B . . . N to form a personal area network (PAN).

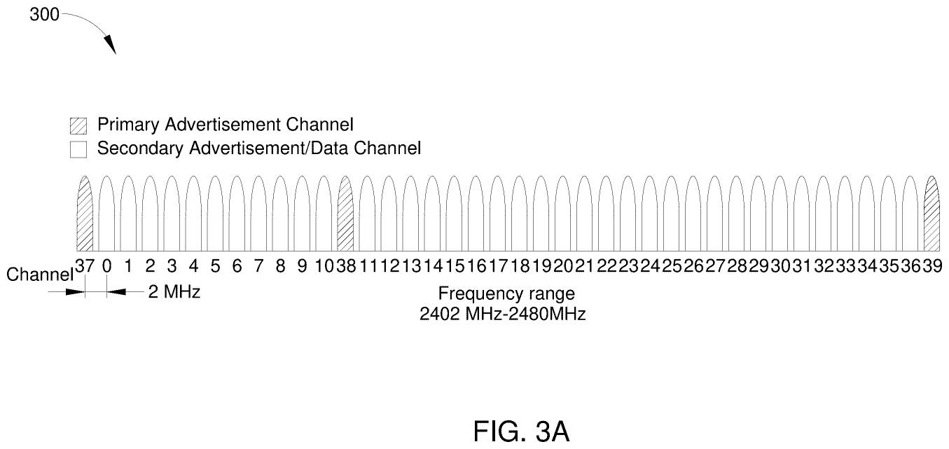

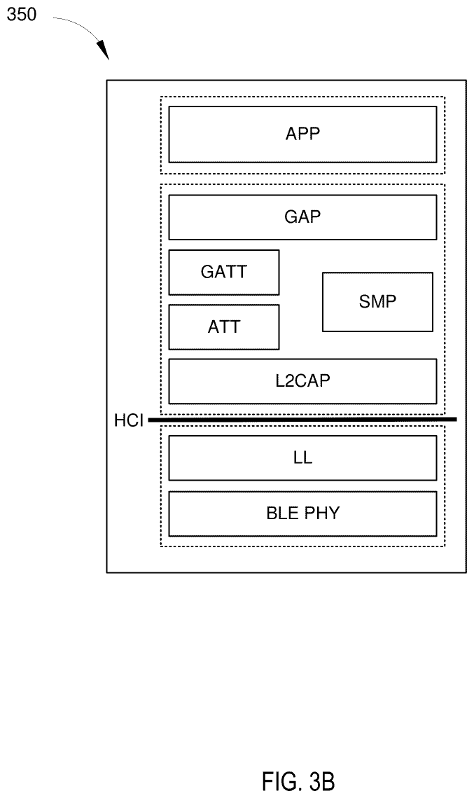

Bluetooth operates in an ISM frequency band, from 2402 Megahertz (MHz) to 2480 MHz. BTC includes 80 channels that are separated by 1 MHz channels. BLE includes a frequency band 300 of 40 channels separated by 2 MHz. as shown in FIG. 3A. Selected channels, including channels 37, 38 and 39 are used for advertising and scanning to form a connection between the primary wireless device and the secondary wireless device(s). These channels are referred to as primary advertising channels. The other 37 channels, referred to as secondary advertising channels or data channels, may be used for communicating control information and data transfer between the primary wireless device 106A and the secondary wireless device(s) 106B . . . N.

FIG. 3B is an example illustration of a BLE protocol stack 350. As shown in FIG. 3A, the BLE PHY air interface operates in the same unlicensed 2.4 GHz Industrial, Scientific, and Medical (ISM) frequency band. In some embodiments, the BLE PHY air interface operates in the range 2400 MHz to 2483.5 MHz. However, other bands may also be used, including ISM bands. The BLE channel bandwidth is 2 MHz. The operating band is divided into 40 channels, k=0, . . . , 39. User data packets are transmitted using channels in the range [0, 36]. Advertising data packets are transmitted in channels 37, 38, and 39. A Gaussian frequency shift-keying (GFSK) modulation scheme is implemented. The BLE PHY uses frequency-hopping spread spectrum (FHSS) to reduce interference and to counter the impact of fading channels.

The Link Layer (LL) performs tasks similar to the medium access control (MAC) layer of the Open Systems Interconnection (OSI) model. In Bluetooth, the LL interfaces directly with the BLE PHY and manages the link state of the radio to define the role of a device as Central, Peripheral, Advertiser, or Scanner. The combined elements of the BLE PHY and the LL are referred to as the controller.

The host controller interface (HCI) handles the interface between the Bluetooth host and the controller. The HCI defines a set of commands and events for transmission and reception of packet data. When receiving packets from the controller, the HCI extracts raw data at the controller to send to the Bluetooth host.

The combined elements of the HCI, logical link control and adaptation protocol (L2CAP), attribute protocol (ATT), generic attribute profile (GATT), security manager protocol (SMP), and generic access profile (GAP) are referred to as the Bluetooth host.

The HCI, on the host side, handles the interface between the Bluetooth host and the controller. The HCI defines a set of commands and events for transmission and reception of packet data. When transmitting data, the HCI translates raw data into packets to send them from the Bluetooth host to the Bluetooth controller.

The L2CAP encapsulates data from the Bluetooth LE higher layers into the standard Bluetooth LE packet format for transmission or extracts data from the standard Bluetooth LE LL packet on reception according to the link configuration specified at the ATT and SMP layers.

The ATT transfers attribute data between clients and servers in GATT-based profiles. The ATT defines the roles of the client-server architecture. The roles typically correspond to the Central and the Peripheral as defined in the link layer. In general, a device could be a client, a server, or both, irrespective of whether it is a Central or a Peripheral. The ATT also performs data organization into attributes as shown in this figure.

The GATT provides a reference framework for all GATT-based profiles. The GATT encapsulates the ATT and is responsible for coordinating the exchange of profiles in a Bluetooth LE link. Profiles include information and data such as handle assignment, a UUID, and a set of permissions.

For devices that implement the GATT profile, the client is the device that initiates commands and requests toward the server. The client can receive responses, indications, and notifications. The server is the device that accepts incoming commands and requests from the client. The server sends responses, indications, and notifications to the client. The GATT uses a client-server architecture. The roles are not fixed and are determined when a device initiates a defined procedure. Roles are released when the procedure ends.

The SMP applies security algorithms to encrypt and decrypt data packets. This layer defines the initiator and the responder, corresponding to the Central and the Peripheral, once the connection is established.

The GAP specifies roles, modes, and procedures of a device. It also manages the connection establishment and security. The GAP interfaces directly with the Application Profiles and Services (APP) layer.

The App layer is the direct user interface defining profiles that afford interoperability between various applications. The Bluetooth core specification enables vendors to define proprietary profiles for use cases not defined by SIG profiles.

The example illustration of the BLE protocol stack in FIG. 3B is not intended to be limiting. Other layer setups can also be used, including the BTC protocol stack.

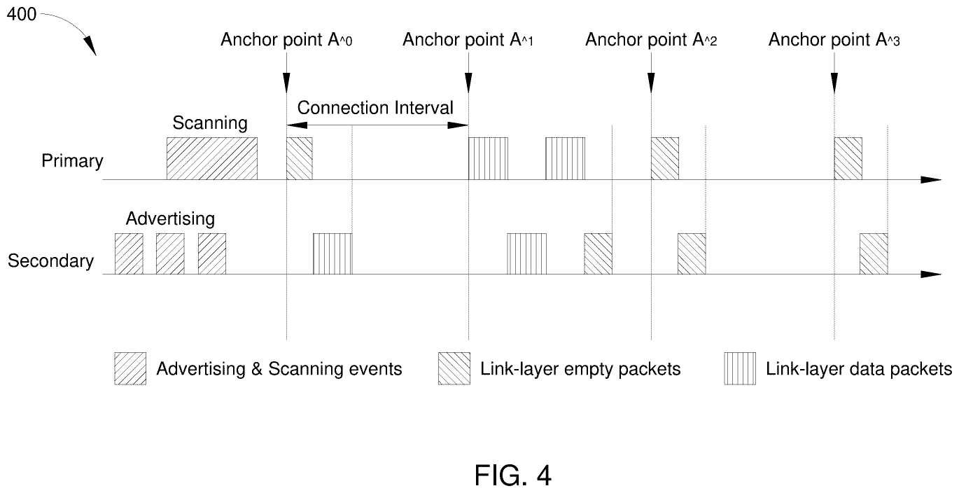

FIG. 4 is an example illustration of a communication 400 between a primary wireless device 106A and a secondary wireless device 106B for Bluetooth (e.g., BLE). In this example, the secondary wireless device 106B broadcasts a series of advertising packets. The primary wireless device scans for the advertising packets. When an advertising packet is received, the information in the advertising packet is used to establish a connected mode between the wireless devices 106A, and 106B . . . N. During the connected mode, the primary wireless device and the secondary wireless device(s) 106B . . . N can both transmit and receive data and control information on channels 0 to 36. Each transmission starts at an anchor point. The anchor point is used to synchronize a clock between the two devices. For example, the secondary wireless device 106B can use the last anchor point and an offset to calculate its next anchor point time, along with transmit and receive times.

The period between the two anchor points, such as A0 and A1 in FIG. 4, is referred to as a connection interval. During the connection interval, the primary wireless device 106A and the secondary wireless device 106B can transmit and receive link-layer packets. The primary wireless device can transmit the first link-layer packet. The length of the transmission is less than the length of the connection interval. The secondary wireless device can then respond by transmitting a link-layer packet to the primary wireless device.

There are two types of link-layer packets. The first type of packet, a link-layer data packet, is a packet that includes data in the payload of the packet. The wireless devices can also transmit packets that don't include data, which are referred to as link-layer empty packets. The link-layer empty packet can include header information in the packet. The last communication in a connection interval can be from the secondary wireless device 106B, which is typically a link-layer empty packet indicating that there is no further data to transmit and confirming the end of a connection event between the primary wireless device 106A and the secondary wireless device(s) 106B . . . N.

The example of FIG. 4 is not intended to be limiting. There are a number of different types of communication that can take place according to one or more of the Bluetooth specifications. Rather, the example of FIG. 4 is used to illustrate the connection of two Bluetooth configured devices, such as the primary wireless device 106A and the secondary wireless device 106B and the transmission of packets between the devices.

As previously discussed, communication in the ISM 2.4 GHz band can be very crowded, with a number of different types of communication standards and devices that use the ISM bands, including but not limited to Bluetooth, IEEE 802.11, wireless intercoms, walkie talkies, and microwave ovens. Each of these devices can create interference and/or noise in one or more channels of the Bluetooth frequency band.

To manage interference, Bluetooth uses adaptive frequency hopping (AFH) using, for example, frequency hopping spread spectrum (FHSS). With AFH, the transmitter and receiver hop to a different channel on a periodic basis. If potential interference is only affecting some of the 80 channels for BTC or 40 channels for BLE, the frequency hopping can be effective in providing open channels for communication.

In order for the transmitter and receiver(s) to be synchronized to enable synchronous channel hopping, the hopping pattern can be derived from the clock and Bluetooth device address of the primary wireless device 106A. The secondary wireless device clock is synchronized to the primary wireless device clock by adding an offset to the secondary wireless devices' native clock. The offsets are updated regularly, since the device clocks are independent. Thereby all devices within a Bluetooth personal area network (e.g. 106A and 106B . . . N) are time and frequency synchronized.

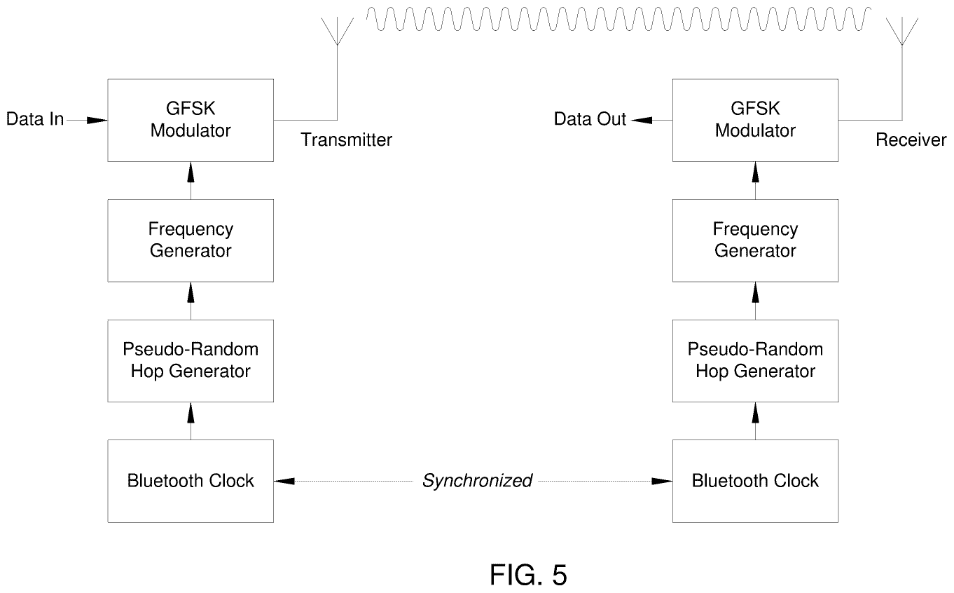

A typical setup with a Bluetooth transmitter and a Bluetooth receiver both synchronized is shown in the block diagram illustrated in FIG. 5, in which a gaussian frequency shift keying (GFSK) modulator is used. This example is not intended to be limiting. Other types of frequency shift keying or phase shift keying modulators may also be used.

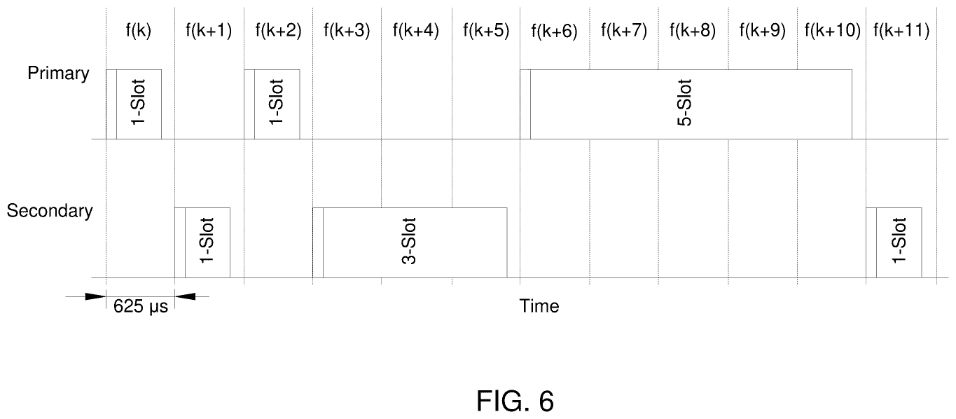

FIG. 6 provides an example illustration of a multi-slot packet transmission and frequency hop scheme. As shown in FIG. 6, Bluetooth transmission channels are divided into time slots, with each slot being 625 us in length. The slots are numbered according to the most significant 27 bits of the BT clock. The time slot number, denoted as “k”, therefore ranges from 0 to 2²⁷−1. With the time slot period of 625 μs, if the wireless devices hop to a new channel every slot, it will result in 1600 hops per second. Bluetooth packets can be either 1, 3, or 5 slots in duration. Accordingly, the frequency hopping rate can be dependent on the length of the packets transmitted between the primary wireless device 106A and the secondary wireless device(s) 106B . . . N.

In order to synchronize the channel hopping for AFH, both the primary wireless device 106A and the secondary wireless device(s) 106B . . . N can use the same pseudo-random number generator. Bluetooth uses two types of channel selection algorithms (CSAs) to determine the channel for both the primary wireless device and the secondary wireless device(s). The second CSA algorithm was introduced in Bluetooth release 5.0. Devices that are configured for earlier releases use the first CSA algorithm.

Each CSA uses the same pseudo-random number generator sharing the same parameters, so the primary wireless device 106A and the secondary wireless devices 106B . . . N are able to hop to the same channel for every slot or connection event. By continuously hopping to another channel for each new slot or connection event, the BLE devices are able to avoid interference from the last connection channel, if any.

The term ‘Adaptive’ in AFH comes from the ability of the primary wireless device 106A and all secondary wireless devices 106B . . . N within a PAN to be able to monitor channel conditions and avoid bad channels, if necessary. The channel quality measurements may be made by all devices within the PAN, since interference depends on the device location and transmitted power.

Common metrics for performing measurements on receive channel quality include a measurement of the Received Signal Strength Indication (RSSI) for the bits in a Packet, a measurement of the Bit Error Rate (BER) over a selected period, or a measurement of the Signal to Noise Ratio (SNR) over a selected period. The Bluetooth Core Specification does not mandate the method of channel measurement in order to identify a good channel or a bad channel. Instead, the implementation is left up to the vendor to define or optimize.

A channel noise map, also referred to as a channel interference bitmap, may be created and provided by the primary wireless device 106A. The term “noise” can comprise noise, such as thermal noise, along with radio frequency noise and interference that is occurring within the channel. The bitmap contains the relevant information about the 79/40 frequency channels for BTC and BLE. The channel classification as either a good or bad channel may be based on: a) local measurements (e.g. active or passive assessment in the Controller) b) information from the primary wireless device; or c) report messages in PDUs received from the secondary wireless devices. Used channels are stated as blocked with the return value of 0. Unused channels are stated as clear with a return value of 1, or vice versa.

In one example, the channel inference bitmap is controlled by the primary wireless device 16A. The channel noise bitmap can be communicated to each of the secondary wireless device(s) 106B . . . N. The channel noise bitmap can be actively updated by the primary wireless device and communicated to the secondary wireless device(s). An example channel bitmap for BLE is illustrated below in Table 1. It should be noted that the channel bitmap can also include the advertising/scanning channels of channel 37, 38 and 39. For BTC, the channel bitmap can be extended to cover 80 channels.

TABLE 1

| Channel | Available |
|---|---|
| 0 | 0 |
| 1 | 1 |
| 2 | 1 |
| 3 | 1 |
| 4 | 0 |
| 5 | 0 |
| 6 | 1 |
| . . . | . . . |
| 37 | 0 |
| 38 | 1 |
| 39 | 1 |
| . . . | . . . |
| 79 | 1 |

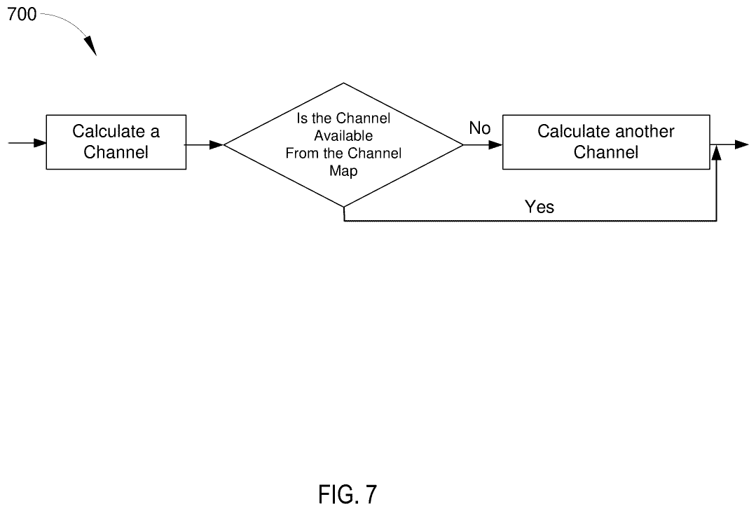

When the channel noise bitmap is used, the CSA can use the flowchart 700 illustrated in FIG. 7. In accordance with some embodiments, the CSA can calculate a channel. For example, the channel may be calculated using a pseudo random number generator. The CSA can then determine if the channel is available from the channel noise bitmap. The channel may be available, or clear, if the bit value for the channel in the bitmap is “1” and unavailable, or blocked if the bit value for the channel in the bitmap is “0”, or vice versa. If the channel is available, then the channel can be used for transmission and reception between the primary wireless device 106A and secondary wireless device(s) 106B . . . N. If the channel is not available, then the CSA can generate the next channel for the primary wireless device and the secondary wireless device(s). The flowchart process can be repeated again until a channel is available.

In some embodiments, the primary wireless device 106A and the secondary wireless device(s) 106B . . . N may share the same channel noise bitmap that is updated by the primary wireless device. The BLE devices may not use blocked channels until they are unblocked again. The channel noise bitmap sets all channels available by default at the beginning of a connection. The channel noise bitmap may be updated after entering the connection-oriented communication after the advertising and scanning is performed and a connection is made between the wireless devices. The primary wireless device can update the channel map without being requested.

As previously discussed, the Bluetooth Core Specification does not mandate the method of channel measurement in order to identify a good channel (e.g. an available channel) or a bad channel (e.g. an unavailable channel). Nor does the specification mandate how often the bitmap is to be updated. Instead, the implementation is left up to the vendor to define or optimize. However, the specification does suggest, for vendors that use the bitmap, that transmission may only be performed when there are 20 or more channels available for frequency hopping for BLE systems, or 40 or more channels available for frequency hopping for BTC systems.

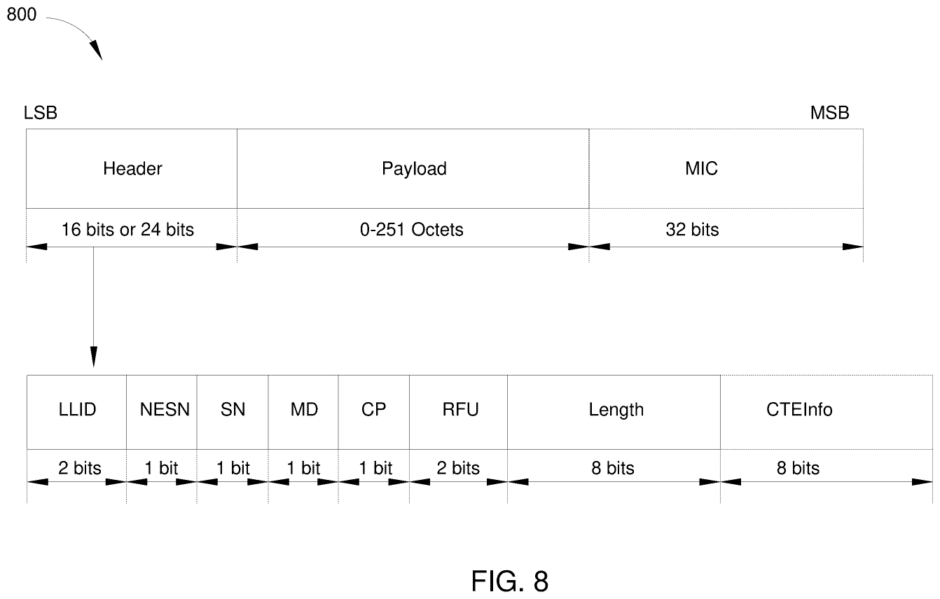

FIG. 8 provides an example illustration of a BLE link layer control protocol data unit (PDU), also referred to as a data physical channel PDU. The PDU 800 comprises: a header, which can be either 16 or 24 bits; a payload which can be from 0 to 251 octets; and a message integrity check (MIC) field that comprises 32 bits.

The header of the PDU 800 comprises 8 fields. The description of the fields is not intended to be limiting. Rather, the description is intended to provide examples of a BLE link layer (LL) PDU header.

A 2 bit link layer identification (LLID) field in the PDU 800 header may indicate whether the packet is a link-layer data PDU or a link layer control PDU.

A 1 bit next expected sequence number (NESN) field is used by the link layer to either acknowledge the last data physical channel PDU sent by the peer (e.g. primary or secondary wireless device) or to request the peer to resend the last data physical channel PDU. This will be described more fully below.

A 1 bit sequence number (SN) field is used by the link layer to identify the BLE packets sent by it.

A 1 bit more data (MD) field indicates that the primary or secondary wireless device has more data to send. If neither of the primary and secondary device has set the MD bit in their packets, the packet from the secondary wireless device closes the connection event, as described in FIG. 4. If the primary and secondary wireless devices have set the MD bit, the primary wireless device can continue the connection event by sending another packet, and the secondary wireless device can listen after sending its packet.

A constant tone extension information (CTEInfo) present (CP) field indicates whether the data physical channel PDU header has a CTEInfo field and, subsequently whether the data physical channel packet has a CTE.

A length field indicates the size, in octets, of the payload and MIC, if present. The size of this field is in the range [0, 255] octets.

A CTEInfo field indicates the type and length of the CTE. The number of symbols in the CTE field are configured by higher layers so that a suitable amount of data and time is available for IQ sampling.

When PDUs are transmitted by the primary wireless device to the secondary wireless device, or vice versa, there is an acknowledgment process used to indicate to the sender that the PDU was successfully received and decoded. In BLE, the acknowledgement process is performed using the NESN and SN fields in the header, such as the header illustrated in FIG. 8.

In one example, the NESN and SN are used for data flow and making sure data is not missed (ACKs and NACKs). The NESN and SN fields are independently appraised. When a sending wireless device sends a packet, the NESN is the next expected SN from the other side in the next packet coming back. When the device receives a packet it looks at the NESN field value and compares it to the previous SN that it sent. If the values are different then that means that it's an acknowledgement (ACK), indicating that the other side received, decoded, and accepted the previous packet correctly. If the NESN and SN are the same (e.g. both 0 or both 1), that means that the sender NACK′ed the previous packet (either didn't receive, couldn't decode it, or rejected the packet because of a lack of buffer space) which triggers a resend of the previous data packet that the wireless device had sent. The device also looks at the SN, and if it was the same as the previous NESN (expected sequence number from the other side) that it sent, then it's expected data. Otherwise, that means the data is old and can be discarded.

Accordingly, when a packet, such as a BLE packet is transmitted from a primary wireless device to a secondary wireless device, or vice versa, and the packet is not correctly received and acknowledged, then the wireless device that transmitted the packet re-sends the packet. The wireless device that received the packet typically starts the reception process over and attempts to decode the transmitted packet again.

In some wireless environments, the noise and/or interference in the wireless environment makes it difficult to receive a packet. Most wireless devices are designed to receive a packet with a signal to noise ratio (SNR), signal to interference plus noise ratio (SINR), or another desired metric, that is greater than a selected threshold value.

If the SNR or SINR is less than the threshold, there may not be enough energy in the signal relative to the noise and/or interference for the receiver to correctly identify the bits in the packet. In the current BLE specifications, the receiving device signals, via the SN and NESN fields, that a packet, such as the PDU, needs to be re-sent by the transmitting device. The receiving device then attempts to decode the PDU a second time. If the noise and/or interference is lower, and/or the signal power is higher, (e.g. a greater SNR or SINR), then the receiving device may be able to correctly decode the re-transmitted packet. However, if the SNR or SINR is lower, then the receiving device may not be able to correctly decode the re-transmitted packet. If the packets are not able to be decoded over a period of time, then the link between the transmitting device and the receiving device may fail.

In accordance with some embodiments, rather than disposing of a packet, such as a BLE packet or a BTC packet, at the receiving wireless device (e.g. the primary wireless device 106A or one or more of the secondary wireless devices 106B . . . N), the receiving wireless device can save the first received signal with a received packet at a selected memory location. The receiving wireless device can indicate, via the SN and NESN fields, to the transmitting wireless device, to re-send the packet that wasn't decoded. The receiving wireless device can receive the re-transmitted signal with the packet and add the energy (e.g. amplitude) in the re-transmitted signal (e.g. a second repeated packet) to the energy or amplitude in the first received signal. If the packet still cannot be correctly decoded (based on the MIC), then the receiving device can again request for the packet to be re-transmitted. This can occur up to M times, where M is a positive integer. In addition, each of the M re-transmitted packets can be transmitted on N frequency hopping channels, where N is a positive integer. By re-transmitting the packets on different frequency hopping channels, the frequency diversity can increase the probability that there is a decreased noise level since noise is typically not broadband.

As the re-transmitted packet is re-sent and the energy in the re-transmitted signal(s) added to the energy of the previously received packet, the noise signal power can average out of the packet signal summation, while the signal power can add in each successive iteration. This enables a packet in a relatively noisy environment to be successfully received even when the SNR or SINR is less than a threshold at which a wireless device, such as the primary wireless device 106A or secondary wireless device(s) 106B . . . N can typically receive a signal.

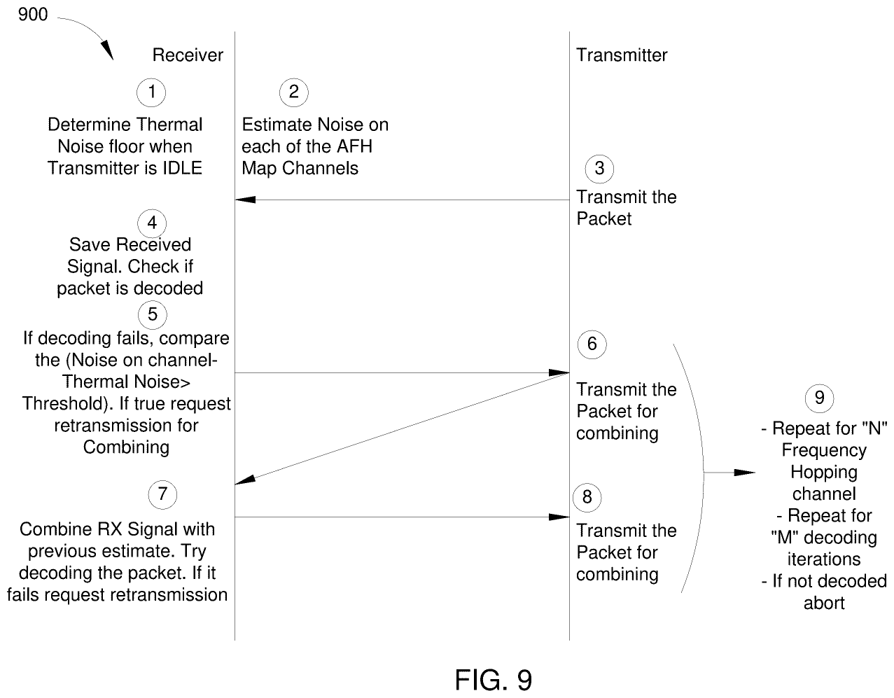

FIG. 9 provides an example illustration of a flowchart 900 for Bluetooth radio decoding with retransmission combining at the receiver, in accordance with some embodiments. Since both the primary wireless device and the secondary wireless device can transmit and receive, FIG. 9 is illustrated from the perspective of a wireless device configured for Bluetooth communication that is receiving packets (e.g. a Bluetooth receiver), and a wireless device configured for Bluetooth communication that is transmitting packets (e.g. a Bluetooth transmitter). The Bluetooth receiver may be a primary wireless device, or a secondary wireless device, as described herein. Conversely, the Bluetooth transmitter may be a secondary wireless device or a primary wireless device.

In this example, the Bluetooth receiver can determine thermal noise, as shown in a first operation of FIG. 9. This operation may not be necessary, but can be helpful in later operations. The thermal noise may be estimated based on the operating conditions of the receiver (e.g. power, temperature, etc.). Alternatively, the thermal noise may be measured, or received from another device, such as a primary wireless device (if the receiver is not the primary wireless device). The thermal noise may be determined when the transmitter is idle. A typical thermal noise per channel may be −113 decibels per milliwatt (dBm).

The Bluetooth receiver can then estimate the noise on selected channels in the AFH map channels, as shown in a second operation of the flowchart 900 of FIG. 9. As previously discussed, the AFH map can be a bitmap showing whether each channel is “good” or “bad”. Each channel can be measured to determine whether it meets a selected threshold level of noise power or interference by the primary wireless device and communicated to the secondary wireless device. In this example, the receiver can calculate the noise power or interference, or receive the AFH map (e.g. the channel interference bitmap) from a primary wireless device, such as the transmitter. There may be 79 channels in the AFH map if the receiver and transmitter are communicating using a BTC specification. There may be 40 channels in the AFH map if the receiver and transmitter are communicating using a BLE specification.

In one embodiment, for each AFH channel in the bitmap that is designated as “good”, the receiver can measure, estimate (or receive) the noise power. Alternatively, the receiver may measure, estimate (or receive) the noise power on each of the 40/79 channels for BLE/BTC communication, or selected channels, such as the primary advertisement channels 37, 38 and 39, or the secondary advertisement channels 0-36, or a desired selection of the channels.

The Bluetooth transmitter can transmit a packet to the receiver, as shown in a third operation of the flowchart 900 of FIG. 9. The Bluetooth receiver can receive a first received packet signal from the Bluetooth transmitter. The Bluetooth receiver can use a baseband processor (or other functionally similar components) to attempt to decode the first received packet signal. If the decoding is successful, the receiver can communicate the data or control information received in the packet to higher layers. The receiver can store the first received packet signal in a memory, such as memory 206 (FIG. 2), as shown in the fourth operation of FIG. 9.

If the decoding of the first received packet signal fails at the Bluetooth receiver, then the Bluetooth receiver can determine the overall noise on the channels in the AFH map. One process, illustrated in a fifth operation in the flowchart 900 of FIG. 9, for determining the noise is to subtract the thermal noise determined in the first operation from the noise on each channel determined in the second operation to calculate the actual channel noise. If the actual channel noise is greater than a selected threshold level, then it may be useful to change the process of receiving packets from the Bluetooth Transmitter.

In the example illustrated in the flowchart 900 of FIG. 9, if the actual noise is greater than the threshold level, then a request for retransmission for combining can be sent to the transmitter. In one example, the request for retransmission for combining may be different from a typical request for retransmission. For example, additional information, in addition to the NESN and SN bits, may be sent by the Bluetooth receiver in the request for retransmission for combining, such as a desired type of retransmission to be performed. The additional information may include 1 or more additional bits in the header. The re-transmission signal may be sent by the transmitter in a way that increases the energy that is received at the receiver and therefore increases the probability of successfully decoding the packet.

Examples of types of re-transmission that can be requested by the Bluetooth receiver include transmitting a rotated or phase shifted version of the packet to provide a cyclic delay diversity improvement at the Bluetooth receiver. In another example, the packet can be re-transmitted as a conjugate after a time delay of t+alpha, where alpha is the time delay. In one example, the Bluetooth receiver and Bluetooth transmitter can be a multiple input multiple output (MIMO) receiver/transmitter.

The transmitter can then re-transmit the same packet that was sent in the third operation, as shown in the sixth operation in the flowchart 900 of FIG. 9. The Bluetooth receiver can receive the re-transmitted packet signal from the Bluetooth transmitter. The Bluetooth receiver can use a baseband processor to attempt to decode the re-transmitted packet signal, as shown in the seventh operation of the flowchart 900 of FIG. 9. As part of the decoding process, the re-transmitted packet signal can be combined with the first received packet signal to form a combined packet signal. If the decoding of the combined packet signal is successful, the receiver can communicate the data or control information received in the packet to higher layers. The receiver can store the re-transmitted packet signal in a memory, such as memory 206 (FIG. 2), as shown in the fourth operation of the flowchart 900 of FIG. 9. Alternatively, the receiver can store the combined packet signal in the memory. The operations of the receiver requesting a retransmission from the transmitter for combining in the fourth operation of FIG. 9, re-transmitting the same packet that was sent in the third operation, as shown in the eighth operation of the flowchart 900 of FIG. 9, combining the re-transmitted packet signal with the stored packet signal(s), and attempting to decode the combined packet signal, as shown in the seventh operation can be repeated for M decoding iterations over N frequency hopping channels, as shown in the ninth operation of the flowchart 900 of FIG. 9, where M and N are positive integers. If the packet still can't be decoded after the M iterations, then the process can be stopped. The process may be attempted again at a later time, at which point the noise and/or interference levels may have decreased sufficiently to receive and decode the packet.

In some embodiments, the process of combining the first received packet signal with the M re-transmitted packet signal(s) may be performed at the bit level. The bits in the first received packet signal and the M re-transmitted packet signal(s) can be aligned in time and/or phase such that each of the corresponding bits in the packets can be combined. In another example, the received first signal can be combined with the M received transmissions of the first signal with soft values using a log likelihood ratio (LLR). These examples are not intended to be limiting. The first received packet signal and the M re-transmitted packet signal(s) can be combined using any technique that increases the probability that the combined signal can be decoded relative to the probability that the first received packet signal can be decoded. By combining the M re-transmitted packet signals, a packet can be decoded in a relatively noisy environment or an environment in which there is significant interference. The packet can be a data packet, a control packet, or an empty packet.

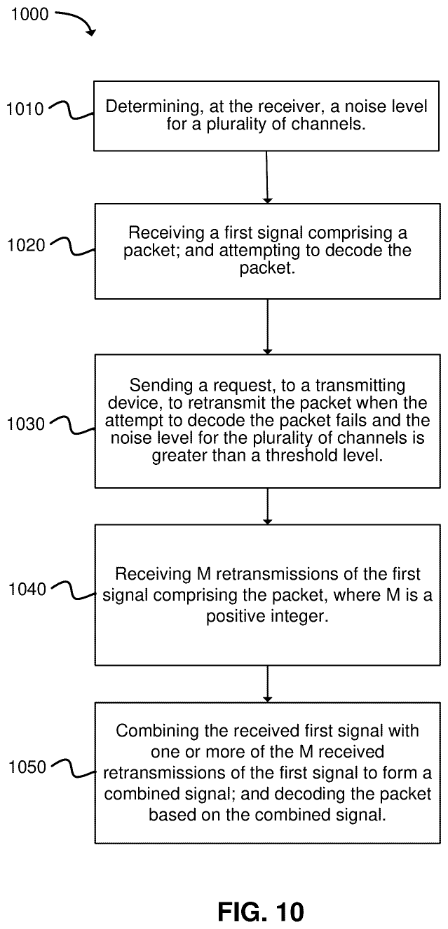

### FIG. 10: Method of Combining Packet Retransmission at a Receiver Configured for Bluetooth

FIG. 10 illustrates an example flowchart of a method 1000 of retransmission packet combining at a receiver, according to some embodiments.

The method shown in FIG. 10 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 1000, of retransmission packet combining at a receiver, comprises determining, at the receiver, a noise level for a plurality of channels, as shown in block 1010. The method 1000 further comprises receiving a first signal comprising a packet, as shown in block 1020. The receiver can attempt to decode the packet and send a request, to a transmitting device, to retransmit the packet when the attempt to decode the packet fails and the noise level for the plurality of channels is greater than a threshold level, as shown in block 1030. In one example, the request may be sent at the link layer. For example, using the SN and NESN fields, the Bluetooth receiver can indicate that the packet was not received when the noise is greater than the threshold. In one example, the noise level threshold may be greater than 40 dB higher than the thermal noise level. In another example, the noise level threshold may be grater than 50 dB higher than the thermal noise. The examples are not intended to be limiting. Depending on the system design, the threshold level of the noise levels may be between 20 and 100 dB greater than the thermal noise.

The method 1000 further comprises receiving M retransmissions of the first signal comprising the packet, where M is a positive integer, where M is a positive integer, as shown in block 1040. The received first signal can be combined with the M received retransmissions of the first signal to form a combined signal. The packet in the combined signal can be decoded based on the combined signal, as shown in bock 1050.

In some embodiments, the operation of determining the noise level in the method 1000 can further comprise the operations of estimating a thermal noise at the receiver; measuring a channel noise level on the plurality of channels; and subtracting the thermal noise from the measured channel noise level to determine the noise level.

In some embodiments, the operation of sending the request to the Bluetooth transmitter to retransmit the packet in the method 1000 further comprises sending the request with a selected retransmission type indicated. The selected retransmission type can comprise requesting, at the Bluetooth receiver, a rotated or phase shifted version of the one or more of the M retransmission signals from the Bluetooth transmitter to provide a cyclic delay diversity improvement in the combined signal at the Bluetooth receiver; or requesting the Bluetooth transmitter to send one or more of the M retransmission signals as a conjugate of the first Bluetooth signal after a time delay of t+alpha, where alpha is the time delay to a time t.

In some embodiments, the method 1000 further comprises storing the received first signal in a memory and storing one or more of the M received retransmission signals in the memory, such that the received first signal can be combined with one or more of the M received retransmission signals.

In some embodiments, the method 1000 further comprises receiving each of the M retransmission signals on a different frequency hopping channel. The M retransmission signals can be received on N frequency hopping channels, where N is a positive integer greater than 1. Receiving the M retransmission signals can further comprise: combining the one of the M retransmission signals with the first received signal to form a combined signal; attempting to decode the packet based on the combined signal; and repeating operations of receiving, combining, and attempting to decode the packet until the combined signal has a sufficient signal to noise ratio to enable successful decoding of the packet.

In some embodiments, the operation of combining the received first signal with the M received retransmissions of the first signal in the method 1000 can further comprise combining the received first signal with the M received retransmissions of the first signal at a bit level.

In some embodiments, the operation of combining the received first signal with the M received retransmissions of the first signal further comprises combining the received first signal with the M received retransmissions of the first signal with soft values using a log likelihood ratio (LLR).

In some embodiments, the operation of combining the received first signal with the M received retransmissions of the first signal further comprises combining M weighted signals equal to 1/M (TX₁(f)+TX₁ (f+β)+TX₁ (f+β₁)+TX₁ (f+β₂)+ . . . N), where X₁(f) is the received signal, and β, β₁, β₂ . . . N are channels in the plurality of FH channels.

In some embodiments, the operation of combining the received first signal with the M received retransmissions of the first signal further comprises combining M weighted signals equal to 1/M (TX1+TX1 (t+α)+TX1 (t+α1)+TX1 (t+α2)+ . . . N), where TX1 is one of the M signals, and α, α1, α2 . . . . N are time shifted signals.

In some embodiments, the method 1000 further comprises determining, at the receiver, the noise level for the plurality of FH channels using a channel noise bitmap, wherein the channel noise bitmap is: received at the receiver; or created at the Bluetooth receiver by measuring the plurality of channels.

In some embodiments, the method 1000 further comprises determining, at the Bluetooth receiver, the noise level for the plurality of channels, wherein the threshold level is based on a number of channels in the channel noise bitmap that have a noise level that is less than a threshold level to enable the channels to transmit and receive. The threshold level for the number of channels in the channel noise bitmap with the noise level that is less than the threshold level is less than or equal to 40 channels in a Bluetooth Classic (BTC) system. In another example, the threshold level can be less than or equal to 20 channels in the BTC system that can transmit and receive. Or the threshold level can be less than or equal to 10 channels in the BTC system that can transmit and receive. Alternatively, the threshold level can be set at less than or equal to 20 channels in a Bluetooth low energy (BLE) system that can transmit and receive, or the threshold level can be less than or equal to 10 channels in the BLE system that can transmit and receive, or the threshold level can be less than or equal to 5 channels in the BLE system that can transmit or receive. In other words, when the number of channels in the channel noise bitmap that can be used for frequency hopping to transmit and receive is less than or equal to 40, or 20, or 10 channels in a BTC system, or less than or equal to 20, or 10, or 5 channels in a BLE system, then the Bluetooth receiver can be configured to combine the M channels for decoding, as previously described.

In some embodiments, the plurality of channels comprises 40 2 Megahertz (MHz) channels for Bluetooth Low Energy (BLE) or 79 1 MHz channels for Bluetooth classic (BTC).

In some embodiments, the operation, in the method 1000, of sending the request to the transmitting device to retransmit the packet when the attempt to decode the packet fails can further comprise sending the request at a link layer using one or more of a sequence number (SN) field and a next expected sequence number (NESN) field to notify the transmitting device to retransmit the packet.

In some embodiments, the Bluetooth receiver is one of a primary wireless device or a secondary wireless device; and the Bluetooth transmitter is one of a secondary wireless device or a primary wireless device.

In some embodiments, a baseband processor configured for the Bluetooth receiver is configured to perform any of the operations of the method 1000.

In some embodiments, an apparatus is configured to cause the Bluetooth receiver, having one or more processors coupled to a memory, to perform any of the operations of the method 1000.

In some embodiments, a computer program product is disclosed that comprises computer instructions which, when executed by one or more processors, perform any of the operations described herein.

In some embodiments, an apparatus of a first wireless device 106A is disclosed. The first wireless device can comprise one or more processors 202 coupled to a memory 206. The one or more processors, coupled to a memory is configured to: determine, at the first wireless device 106A, a noise level for a plurality of channels. The first wireless device 106A can receive a first signal with a packet from a second wireless device 106B. The one or more processors 202, coupled to a memory 206, in the first wireless device 106A can attempt to decode the packet; and send a request to the second wireless device 106B to retransmit the packet when the attempt to decode the packet fails at the first wireless device 106A and the noise level for the plurality of channels is greater than a threshold level at the first wireless device 106A. The first wireless device 106A can receive M retransmission signals of the first signal with the packet, where M is a positive integer; and combine the received first signal with the M received retransmissions of the first signal at the first wireless device 106A to form a combined signal; and decode the packet in the combined signal at the first wireless device 106A.

In some embodiments, the one or more processors 202 coupled to the memory 206 of the apparatus of the first wireless device 106A are further configured to: estimate a thermal noise at the receiver; measure a noise level on the plurality of channels; and subtract the thermal noise from the measured noise level on the plurality of channels to determine the noise level on the plurality of channels.

In some embodiments, the one or more processors 202 coupled to the memory 206 of the apparatus of the first wireless device 106A are further configured to: combine M weighted signals equal to 1/M (TX₁(f)+TX1 (f+β)+TX1 (f+β₁)+TX1 (f+β₂)+ . . . N), where X1(f) is the received signal, and β, β1, β2 . . . N are channels in the plurality of channels; or combining M weighted signals equal to 1/M (TX1+TX1 (t+α)+TX1 (t+α1)+TX1 (t+α2)+ . . . N), where TX1 is one of the M signals, and α, α1, α2 . . . . N are time shifted signals.

Embodiments of the present disclosure may be realized in any of various forms. For example, some embodiments may be realized as a computer-implemented method, a computer readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a WD 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a receiving wireless device (WD) may be the basis of a corresponding method for operating a transmitting wireless device, by interpreting each message/signal X received by the receiving wireless device in the received signal as message/signal X transmitted by the transmitting wireless device, and each message/signal Y transmitted in the receiving wireless device as a message/signal Y received by the transmitting wireless device.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method of retransmission packet combining at a receiver, comprising:
determining, at the receiver, a noise level for a plurality of channels;
receiving a first signal comprising a packet;
attempting to decode the packet;
sending a request, to a transmitting device, to retransmit the packet when the attempt to decode the packet fails and the noise level for the plurality of channels is greater than a threshold level;
receiving M retransmissions of the first signal comprising the packet, where M is a positive integer;
combining the received first signal with one or more of the M received retransmissions of the first signal to form a combined signal; and
decoding the packet based on the combined signal.

2. The method of claim 1, wherein determining the noise level further comprises:
estimating a thermal noise at the receiver;
measuring a channel noise level on the plurality of channels; and
subtracting the thermal noise from the measured channel noise level to determine the noise level.

3. The method of claim 1, wherein sending the request to retransmit the packet further comprises indicating a selected retransmission type.

4. The method of claim 3, wherein the selected retransmission type comprises:
requesting the transmitter to send a rotated or phase shifted version of the one or more of the M retransmission signals to provide a cyclic delay diversity improvement in the combined signal at the receiver; or
requesting the transmitter to send one or more of the M retransmission signals as a conjugate of the first signal after a time delay of alpha, where alpha is the time delay to a time t.

5. The method of claim 1, further comprising storing the received first signal in a memory and storing one or more of the M received retransmission signals in the memory, such that the received first signal can be combined with one or more of the M received retransmission signals.

6. The method of claim 1, further comprising receiving each of the M retransmission signals on a different frequency hopping channel.

7. The method of claim 1, further comprising receiving the M retransmission signals on N frequency hopping channels, where N is a positive integer great than 1.

8. The method of claim 1, wherein receiving the M retransmission signals further comprises:
receiving one of the M retransmission signals;
combining the one of the M retransmission signals with the first received signal to form a combined signal;
attempting to decode the packet based on the combined signal; and
repeating operations of receiving, combining, and attempting to decode the packet until the combined signal has a sufficient signal to noise ratio to enable successful decoding of the packet.

9. The method of claim 1, wherein the received first signal and the M received retransmissions of the first signal are combined at a bit level.

10. The method of claim 1, wherein the received first signal and the M received retransmissions of the first signal are combined with soft values using a log likelihood ratio (LLR).

11. The method of claim 1, wherein combining the received first signal with the M received retransmissions of the first signal further comprises combining M weighted signals equal to 1/M (TX₁(f)+TX₁ (f+β)+TX₁ (f+β₁)+TX₁ (f+β₂)+ . . . N), where X₁(f) is the received signal, and β, β₁, β₂ . . . N are channels in the plurality of FH channels.

12. The method of claim 1, wherein combining the received first signal with the M received retransmissions of the first signal further comprises combining M weighted signals equal to 1/M (TX1+TX1 (t+α)+TX1 (t+α1)+TX1 (t+α2)+ . . . N), where TX1 is one of the M signals, and α, α1, α2 . . . N are time shifted signals.

13. The method of claim 1, further comprising determining, at the receiver, the noise level for the plurality of channels using a channel noise bitmap, wherein the channel noise bitmap is:
received from a primary wireless device; or
created based on measuring the plurality of channels.

14. The method of claim 13, wherein determining the noise level for the plurality of channels further comprises: determining the threshold level based on a number of channels in the channel noise bitmap that have a noise level that is less than a threshold level to enable the channels to successfully transmit and/or receive.

15. The method of claim 14, wherein the threshold level for the number of channels in the channel noise bitmap with the noise level that is less than the threshold level is less than or equal to 40 channels in a Bluetooth Classic (BTC) system, or less than or equal to 20 channels in the BTC system, or less than or equal to 10 channels in the BTC system; or less than or equal to 20 channels in a Bluetooth low energy (BLE) system, or less than or equal to 10 channels in the BLE system, or less than or equal to 5 channels in the BLE system.

16. The method of claim 1, wherein the plurality of channels comprises 40 2 Megahertz (MHz) channels for Bluetooth Low Energy (BLE) or 79 1 MHz channels for Bluetooth classic (BTC).

17. The method of claim 1, wherein sending the request to the transmitting device, to retransmit the packet when the attempt to decode the packet fails, further comprises sending the request at a link layer using one or more of a sequence number (SN) field and a next expected sequence number (NESN) field to notify the transmitting device to retransmit the packet.

18. An apparatus of a first wireless device comprising:
one or more processors, coupled to a memory, configured to:
determine, at the first wireless device, a noise level for a plurality of channels;
receive, at the first wireless device a first signal with a packet from a second wireless device;
attempt to decode the packet at the first wireless device;
send a request to the second wireless device to retransmit the packet when the attempt to decode the packet fails at the first wireless device and the noise level for the plurality of channels is greater than a threshold level at the first wireless device;
receive M retransmission signals of the first signal with the packet at the first wireless device, where M is a positive integer;
combine the received first signal with the M received retransmissions of the first signal at the first wireless device to form a combined signal; and
decode the packet with in the combined signal at the first wireless device.

19. The apparatus of claim 18, wherein the one or more processors and memory are further configured to:
estimate a thermal noise at the first wireless device;
measure a noise level on the plurality of channels; and
subtract the thermal noise from the measured noise level on the plurality of channels to determine the noise level on the plurality of channels.

20. The apparatus of claim 18, wherein the one or more processors and memory are further configured to:
combine M weighted signals equal to 1/M (TX₁(f)+TX₁ (f+β)+TX₁ (f+β₁)+TX₁ (f+β₂)+ . . . N), where X₁(f) is the received signal, and β, β₁, β₂ . . . N are channels in the plurality of channels; or
combining M weighted signals equal to 1/M (TX1+TX1 (t+α)+TX1 (t+α1)+TX1 (t+α2)+ . . . N), where TX1 is one of the M signals, and α, α1, α2 . . . N are time shifted signals.
